(19) United States
(12) Patent Application Publication
(10) Pub. No.: US 2023/0160760 A1
(43) Pub. Date: May 25, 2023

(54) DISTRIBUTED TEMPERATURE SENSING SYSTEM USING MULTICORE OPTICAL FIBER AND METHOD THEREOF

(71) Applicant: FIBERPRO, Inc., Daejeon (KR)

(72) Inventors: Jae Chul YONG, Daejeon (KR); Yun Sook LEE, Daejeon (KR); Bong Wan LEE, Daejeon (KR)

(73) Assignee: FIBERPRO, Inc., Daejeon (KR)

(21) Appl. No.: 18/052,832

(22) Filed: Nov. 4, 2022

(30) Foreign Application Priority Data
Nov. 5, 2021 (KR) 10-2021-0151808

(51) Int. Cl. G01K 11/324; G02B 6/02; G02B 6/42

(52) U.S. Cl. CPC G01K 11/324; G02B 6/02042; G02B 6/4215

(57) ABSTRACT

Disclosed are a distributed temperature sensing system using a multicore optical fiber and a method thereof. The distributed temperature sensing system using the multicore optical fiber is configured to use the multicore optical fiber for a typical distributed temperature sensing system (DTSS), analyze a signal by collecting, for all cores, Raman-scattered light that is backscattered by multiple cores, increase the size of the signal by the number of times corresponding to the number of cores, increase a signal-to-noise ratio (SNR) for the same sensing time, and increase a sensing distance.

### RELATED APPLICATIONS

This application claims priority benefit of Korean Patent Application No. 10-2021-0151808 filed on Nov. 5, 2021, in the Korean Intellectual Property Office, the disclosure of which is incorporated herein by reference for all purposes.

### BACKGROUND

### 1. Field

The disclosure relates to a distributed temperature sensing system (DTSS) and a technique for increasing a signal-to-noise ratio (SNR) and a sensing distance by using a multicore optical fiber.

### 2. Description of Related Art

A typical distributed temperature sensing system senses a temperature of a position where light is scattered by measuring the power of backscattered light after inputting a high-output light pulse to a sensing optical fiber (see KR 10-1095590).

To increase a signal-to-noise ratio (SNR) of the backscattered light and a sensing distance, the typical distributed temperature sensing system increases the power of a light pulse that is input to an optical fiber or sufficiently increases a sensing time.

However, when the power of the light pulse is excessively high, stimulated Raman scattering may occur in an optical fiber that monitors a temperature, and accordingly, a temperature may not be accurately sensed.

In addition, stimulated Raman scattering may occur at lower power in a single-mode optical fiber than in a multi-mode optical fiber.

In an experiment with the single-mode optical fiber, when a full width at half maximum (FWHM) was 10 nanoseconds (ns), stimulated Raman scattering occurred at pulse peak power of 5 watts (W).

In addition, to detect a sudden temperature change, such as fire, within a short time through a distributed temperature sensing system, the total sensing time spent for signal processing by sensing an injected light pulse and reflected light may need to be as short as possible.

### SUMMARY OF THE INVENTION

The present disclosure is to increase a signal-to-noise ratio (SNR), when processing scattered light, in proportion to the number of cores, and to increase a sensing distance upon distributed temperature sensing by collecting, for all cores, the scattered light (e.g., Raman-scattered light) that is backscattered according to the length of an optical fiber and processing the scattered light after inputting a light pulse to each of the multiple cores in a multicore optical fiber by applying the multicore optical fiber, for sensing a temperature, to a distributed temperature sensing system (DTSS).

An aspect provides a DTSS using a multicore optical fiber including a light generator configured to generate a plurality of sensing-light pulses by controlling a plurality of light sources, a light injector configured to input the plurality of sensing-light pulses to a filter array and inject, into the multicore optical fiber, a plurality of first sensing-light pulses corresponding to a selected wavelength that is output from the filter array, a light extractor configured to extract scattered light included in a reflected-light pulse when the reflected-light pulse that is reflected from an end of the multicore optical fiber is input to the filter array, based on the injection of the plurality of first sensing-light pulses, a light sensor configured to convert, to an electrical signal, the scattered light that is extracted by the filter array and transmitted to the light sensor by the light extractor, and a signal processor configured to process the scattered light converted to the electrical signal to generate temperature distribution information according to a length of the multicore optical fiber, in which the reflected-light pulse includes, when the first sensing-light pulses are scattered by each core in the multicore optical fiber, the scattered light generated by each core, and the light extractor is configured to control the filter array and repeatedly extract the scattered light included in the reflected-light pulse by the number of times corresponding to the number of cores in the multicore optical fiber.

Another aspect also provides a distributed temperature sensing method using a multicore optical fiber including generating a plurality of sensing-light pulses by controlling a plurality of light sources, inputting the plurality of sensing-light pulses to a filter array and injecting a plurality of first sensing-light pulses corresponding to a selected wavelength that is output from the filter array into the multicore optical fiber, extracting scattered light included in a reflected-light pulse when the reflected-light pulse that is reflected from an end of the multicore optical fiber is input to the filter array, based on the injection of the plurality of first sensing-light pulses, converting the scattered light extracted by the filter array to an electrical signal, and processing the scattered light converted to the electrical signal to generate temperature distribution information according to a length of the multicore optical fiber, in which the reflected-light pulse includes, when the first sensing-light pulses are scattered by each core in the multicore optical fiber, the scattered light generated by each core, and the extracting the scattered light in the reflected-light pulse includes controlling the filter array and repeatedly extracting the scattered light included in the reflected-light pulse by the number of times corresponding to the number of cores in the multicore optical fiber.

According to an aspect, temperature distribution information having a similar accuracy to that of temperature distribution information obtained by using multiple typical single-mode optical fibers may be obtained within a short time by using a multicore optical fiber for a DTSS.

According to an aspect, an SNR may increase by \sqrt{N} times and a sensing distance upon temperature sensing may increase when using the multicore optical fiber compared to when using the typical single-core optical fibers. The multicore optical fiber having multiple cores may use the multiple cores for sensing a temperature, in which the number of cores that are used for sensing a temperature is N, and thus, the size of a signal may increase when processing the signal of scattered light that is backscattered based on the injection of a sensing-light pulse.

According to an aspect, the SNR may additionally increase by (L+1)/2√L times by applying a cyclic simplex code technique of which a code length is L to a sensing-light pulse input to each core.

According to an aspect, when using a multicore optical fiber having a light circuit in a double-end structure in which every two cores connect to the light circuit, a temperature error between scattered light including stoke components and scattered light including anti-stoke components may be automatically complemented by the light circuit, and the SNR of the DTSS may further increase.

According to an aspect, in applying a complementary technique, when inputting a second sensing-light pulse of which a wavelength is different from that of the sensing-light pulse to the other cores except for the cores to which the sensing-light pulse is input, a quantity of a light source of a typical sensing-light may be cut in half and costs may be reduced.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a block diagram illustrating a configuration of a distributed temperature sensing system using a multicore optical fiber, according to an example embodiment;

FIG. 2 is a diagram illustrating an example of a configuration of a distributed temperature sensing system using a multicore optical fiber;

FIG. 3 is a diagram illustrating an example of another configuration of a distributed temperature sensing system using a multicore optical fiber, according to an example embodiment;

FIG. 4 is a diagram illustrating an example of another configuration of a distributed temperature sensing system using a multicore optical fiber, according to an example embodiment;

FIG. 5 is a diagram illustrating an example of another configuration of a distributed temperature sensing system using a multicore optical fiber, according to an example embodiment; and

FIG. 6 is a flowchart illustrating an order of a distributed temperature sensing method using a multicore optical fiber, according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

A distributed temperature sensing system using a multicore optical fiber may use the multicore optical fiber, analyze a signal by collecting, for all cores, Raman-scattered light that is backscattered by multiple cores, increase the size of the signal by the number of times corresponding to the number of cores, increase a signal-to-noise ratio (SNR) for the same sensing time, and increase a sensing distance.

The multicore optical fiber herein may be an optical fiber for sensing a temperature that includes multiple cores, in which the multicore optical fiber may have a similar structure to a structure of bundling multiple general optical fibers each including one core into one optical fiber, but the geometric structure inside the multicore optical fiber is different from that of the general optical fibers.

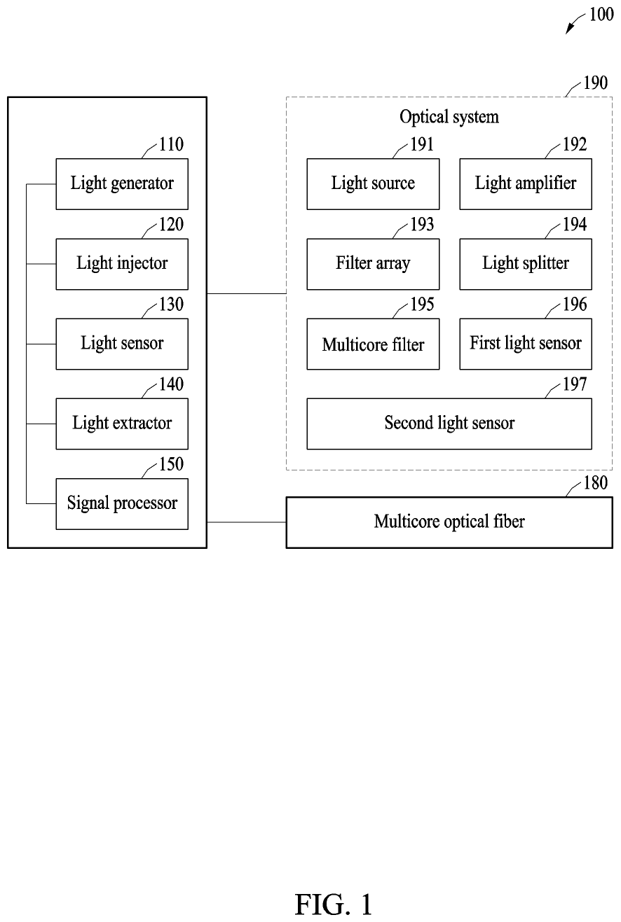

FIG. 1 is a block diagram illustrating a configuration of a distributed temperature sensing system using a multicore optical fiber, according to an example embodiment.

Referring to FIG. 1, a distributed temperature sensing system 100 using a multicore optical fiber 180 may include a light generator 110, a light injector 120, a light sensor 130, a light extractor 140, a signal processor 150, the multicore optical fiber 180, and an optical system 190.

For example, the optical system 190 may include a light source 191, a light amplifier 192, a light splitter 194, a filter array 193 or a multicore filter 195, and a first light sensor 196 or a second light sensor 197.

In this case, the filter array 193 may include a combination of a ‘selection filter’ selecting a certain wavelength and a ‘Raman filter’. Each of a plurality of cores included in the multicore filter 195 may include a combination of a ‘selection filter’ selecting a certain wavelength and a ‘Raman filter’.

The light generator 110 may control a plurality of light sources 191 and generate a plurality of sensing-light pulses.

For example, the light generator 110 may control the plurality of light sources 191 such that an output pulse value of the plurality of sensing-light pulses generated by all the light sources 191 may not exceed a predetermined upper limit.

In other words, the light generator 110 may generate the plurality of sensing-light pulses having a highest possible output pulse value at a level where stimulated Raman scattering does not occur when each of the plurality of sensing-light pulses passes through the filter array 193.

The light generator 110 may generate the sensing-light pulses at sufficiently high light power and may increase an SNR in the distributed temperature sensing system 100 and the accuracy of temperature sensing by preventing stimulated Raman scattering.

In another example, the light generator 110 may selectively transmit a control command to one light source 191 among the plurality of light sources 191.

In this case, the light generator 110 may generate a single sensing-light pulse by the light source 101 and may split the single sensing-light pulse into a plurality of sensing-light pulses by using the light splitter 194 such that the plurality of sensing-light pulses may be used by the light injector 120.

The light injector 120 may inject the plurality of sensing-light pulses into the multicore optical fiber 180 through the filter array 193.

The light injector 120 may input the plurality of sensing-light pulses to the filter array 193 and may inject, into the multicore optical fiber 180, a plurality of first sensing-light pulses corresponding to a selected wavelength that is output from the filter array 193.

For example, the filter array 193 may remove a second sensing-light pulse of a wavelength that is not selected from among the plurality of sensing-light pulses and may pass the plurality of first sensing-light pulses corresponding to the selected wavelength. The light injector 120 may inject, into the multicore optical fiber 180, the plurality of first sensing-light pulses that passes through the filter array 193.

In another example, the filter array 193 may not remove the second sensing-light pulse of the wavelength that is not selected from among the plurality of sensing-light pulses and may pass the second sensing-light pulse. The light injector 120 may inject the second sensing-light pulse that passes through the filter array 193 into other cores in the multicore optical fiber 180 into which the first sensing-light pulses are not injected.

The light extractor 140 may extract scattered light included in a reflected-light pulse when the reflected-light pulse that is reflected from an end (rear) of the multicore optical fiber 180 is input to the filter array 193, based on the injection of the plurality of first sensing-light pulses.

For example, the filter array 193 may include a combination of a selection filter and a Raman filter, in which the selection filter selects a wavelength of the plurality of first sensing-light pulses to be passed from among the plurality of sensing-light pulses that is input to the filter array.

The first sensing-light pulses are scattered by each core in the multicore optical fiber 180, and scattered light generated by each core may be included in the reflected-light pulse. The light extractor 140, by controlling the filter array 193, may repeatedly extract the scattered light included in the reflected-light pulse by the number of times corresponding to the number of cores in the multicore optical fiber 180.

The filter array 193 may remove a light source 191 component by filtering the first sensing-light pulses that are input together with the reflected-light pulse to the filter array 193.

Thereafter, the filter array 193 may extract the scattered light included in the reflected-light pulse by separating the scattered light into first scattered light including stoke components and second scattered light including anti-stoke components.

The light sensor 130 may convert, to an electrical signal, the scattered light extracted by the filter array 193 and transmitted to the light sensor 130 by the light extractor 140.

For example, the light sensor 130 may respectively convert, to electrical signals, the first scattered light and the second scattered light that are separated and extracted by the filter array 193.

The signal processor 150 may processing the scattered light converted to the electrical signal to generate temperature distribution information according to the length of the multicore optical fiber 180.

The signal processor 150 may generate the temperature distribution information by processing the first scattered light and the second scattered light that are respectively converted to the electrical signals.

For example, in the multicore optical fiber 180 having N cores (in which N is a natural number greater than or equal to 2), the filter array 193 may separate N pieces of scattered light into first scattered light including N stoke components and second scattered light including N anti-stoke components and extract the first scattered light and the second scattered light, and the light sensor 130 may respectively convert N pieces of first scattered light and N pieces of second scattered light to electrical signals. The signal processor 150 may generate the temperature distribution information according to the length of the multicore optical fiber 180 by processing a sum obtained by adding N pieces of first scattered light converted to electrical signals and a sum obtained by adding N pieces of second scattered light converted to electrical signals.

Accordingly, an SNR may increase by summing and processing the pieces of scattered light extracted by the number of times corresponding to the number (N) of cores, and a sensing distance upon distributed temperature sensing may increase.

According to example embodiments, the other end of the multicore optical fiber 180 may include a light circuit having a double-end structure in which every two cores in the multicore optical fiber 180 are connected to the light circuit.

The light circuit may minimize, in the multicore optical fiber 180, a loss error according to a wavelength between the first scattered light including stoke components and the second scattered light including anti-stoke components.

In other words, the light circuit may automatically compensate for a temperature error generated between the first scattered light including stoke components and the second scattered light including anti-stoke components, and an SNR of each piece of scattered light may increase.

There may be one or more pairs of light circuits depending on the number of cores in the multicore optical fiber 180, and an SNR may increase as the number of light circuits increases.

In addition, of the two cores of the light circuit, to the other core except for the core to which the first sensing-light pulses are input, the light injector 120 may input the second sensing-light pulse that is generated to maintain an amplification rate of the light amplifier 192 and of which a wavelength is different from that of the first sensing-light pulses. In this case, a cyclic simplex code technique may be applied to the two cores with one light source 191 and a temperature may be sensed.

According to example embodiments, the signal processor 150, to increase an SNR of each piece of scattered light extracted by the number of times corresponding to the number of cores, may apply a cyclic simplex code technique to each piece of scattered light in a selected condition.

In applying the cyclic simplex code technique to each piece of scattered light, for a total time corresponding to the length of the multicore optical fiber 180, a plurality of first sensing-light pulses of a certain wavelength may be injected into the multicore optical fiber 180 through the filter array 193 and the scattered light may be repeatedly extracted from the reflected-light pulse by the number of times corresponding to the number of cores in the multicore optical fiber 180 with a predetermined delay time. In this condition, the signal processor 150 may apply a cyclic simplex code technique to each piece of scattered light extracted by the number of times corresponding to the number of cores.

In other words, when a cyclic pattern in which the sensing-light pulse is injected is known and the interval of extracting the scattered light from the reflected-light pulse is constant, the signal processor 150 may apply a cyclic simplex code technique to stoke and anti-stoke signals of multiple cores. Compared to a result of applying a cyclic simplex code technique to a typical single-core optical fiber, an SNR may further increase by times (in which, is the number of cores).

According to example embodiments, the light injector 120 may use the multicore filter 195 instead of the filter array 193, input each of the plurality of sensing-light pulses to each core in the multicore filter 195, and inject, into each core in the multicore optical fiber 180, each of the plurality of first sensing-light pulses corresponding to the selected wavelength that is output from each core in the multicore filter 195.

In this case, when a reflected-light pulse that is reflected from an end of the multicore optical fiber 180 is input to the multicore filter 195, the light extractor 140 may extract scattered light included in the reflected-light pulse through the multicore filter 195.

The light sensor 130 may sense the scattered light extracted through the multicore filter 195 by using the first light sensor 196 having a large area corresponding to an area occupied by the multicore filter 195.

In addition, the light sensor 130 may sense the scattered light extracted through the multicore filter 195 by using the second light sensor 197 that is pigtailed to the multicore optical fiber 180.

When using the multicore filter 195 and the first light sensor 196 having a large area or the second light sensor 197 that is pigtailed thereto, the distributed temperature sensing system 100 may be simply configured.

In addition, according to example embodiments, the light injector 120, by using the light amplifier 192, may amplify sensing-light pulses generated by the light source 191, inject the amplified sensing-light pulses into the multicore optical fiber 180, and increase an SNR through high-output sensing-light pulses.

To this end, the light injector 120 may input each sensing-light pulse to the light amplifier 192 at predetermined intervals, the light amplifier 192 may amplify an output pulse value of each sensing-light pulse, and the light injector 120 may inject each sensing-light pulse into the multicore optical fiber 180 by passing each sensing-light pulse through the filter array 193.

When a sensing-light pulse is not input to the light amplifier 192 by the light source 191 even at a predetermined interval, the light injector 120 may input a second sensing-light pulse, instead of the sensing-light pulse, to the light amplifier 192 in which the second sensing-light pulse generated through a complementary technique and has a wavelength that is different from that of a first sensing-light pulse.

In this case, the amplification rate of a sensing-light pulse may be maintained constant and the output pulse value of the first sensing-light pulse injected into the multicore optical fiber 180 may be uniform. Therefore, the performance of the distributed temperature sensing system 100 may be improved.

Other than using the second sensing-light pulse for maintaining the amplification rate of a sensing-light pulse, the second sensing-light pulse may also be used for actually sensing a temperature.

Specifically, when there is a first core (that is, a core of which a temperature value is yet to be sensed), in the multicore optical fiber 180, where the sensing-light pulse is not scattered, the second sensing-light pulse may not be removed (filtered) and may be used for sensing the temperature value of the first core by being injected into the multicore optical fiber 180 through the filter array 193.

Accordingly, temperature distribution information having a similar accuracy to that of temperature distribution information obtained by using multiple typical single-mode optical fibers may be obtained within a short time by using a multicore optical fiber for a distributed temperature sensing system.

Since a multicore optical fiber having multiple cores is used for sensing a temperature, an SNR may increase in proportion to the number of cores when processing scattered light backscattered based on the injection of the sensing-light pulse, and a sensing distance upon distributed temperature sensing may increase.

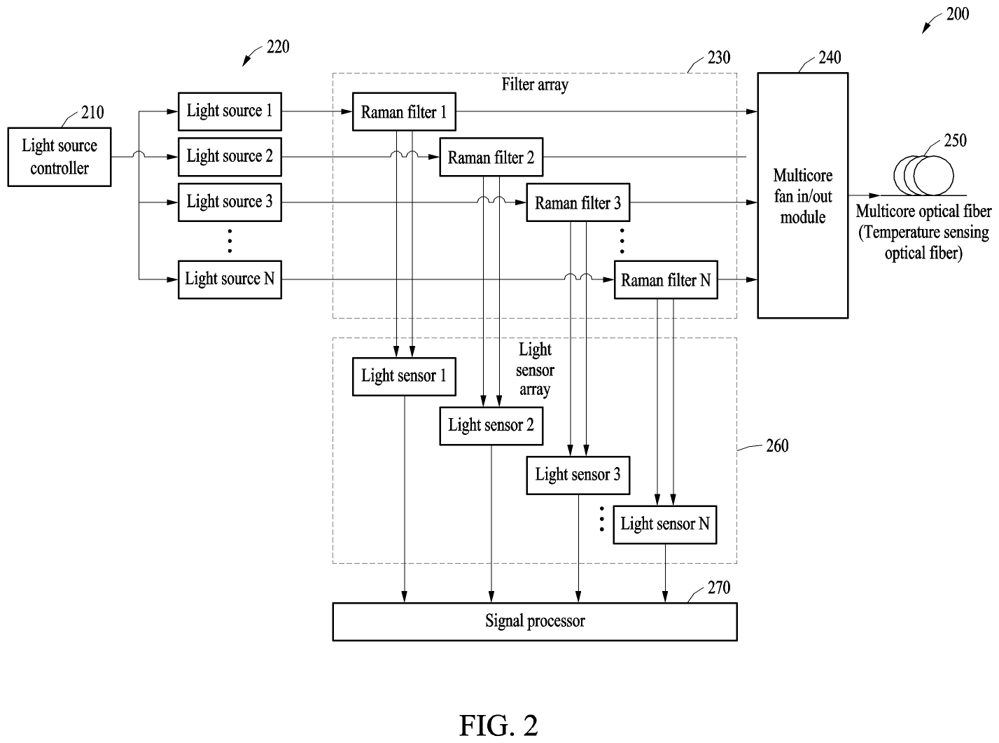

FIG. 2 is a diagram illustrating an example of a configuration of a distributed temperature sensing system using a multicore optical fiber.

Referring to FIG. 2, a distributed temperature sensing system 200 using a multicore optical fiber 250 may include a light source controller 210, N light sources 220, a filter array 230, a multicore fan in/out module 240, the multicore optical fiber 250, a light sensor array 260, and a signal processor 270.

The light source controller 210 may modulate current that is input to the N light sources 220 and generate each of sensing-light pulses having light that is output as a pulse.

The filter array 230 may include N filters respectively corresponding to the N light sources 220. The filter array 230 may include a combination of a ‘selection filter’ selecting a certain wavelength and a ‘Raman filter’.

The multicore fan in/out module 240 may inject, into each core of the multicore optical fiber 250, each of the sensing-light pulses that are generated by the N light source 220 and input to each filter.

Each sensing-light pulse injected into the multicore optical fiber 250 may generate scattered light through Raman scattering while moving to and from each core in the multicore optical fiber 250 and may be reflected to the rear of the multicore optical fiber 250.

The signal processor 270 to be described below may process the scattered light and sense a temperature at each core, that is, a position where the scattered light is generated.

The scattered light generated at each core, as a reflected-light pulse, together with the sensing-light pulse injected into the multicore optical fiber 250, may be reflected to the rear of the multicore optical fiber 250 and may be input to the filter array 230 by the multicore fan in/out module 240.

The N filters of the filter array 230 may obtain the scattered light (e.g., Raman-scattered light) by filtering the sensing-light pulse corresponding to an original light source and may separate the obtained scattered light into first scattered light including stoke components and second scattered light including anti-stoke components.

The light sensor array 260 may include N light sensors respectively corresponding to the N filters.

Each light sensor may convert, to an electrical signal, the first scattered light and the second scattered light separated by each filter corresponding to the light sensor and may input the electrical signal to the signal processor 270.

The signal processor 270 may collect and process N pieces of first scattered light and N pieces of second scattered light that are input by the light sensor array 260 to the signal processor 270 and may calculate temperature distribution corresponding to the length of the multicore optical fiber 250.

Accordingly, a signal size of scattered light may increase by the number of times corresponding to the number (N) of cores in the multicore optical fiber 250 by using the multicore optical fiber 250 for the distributed temperature sensing system 200 as compared to using a typical single-mode optical fiber, and thus, an SNR may increase by \sqrt{N} times.

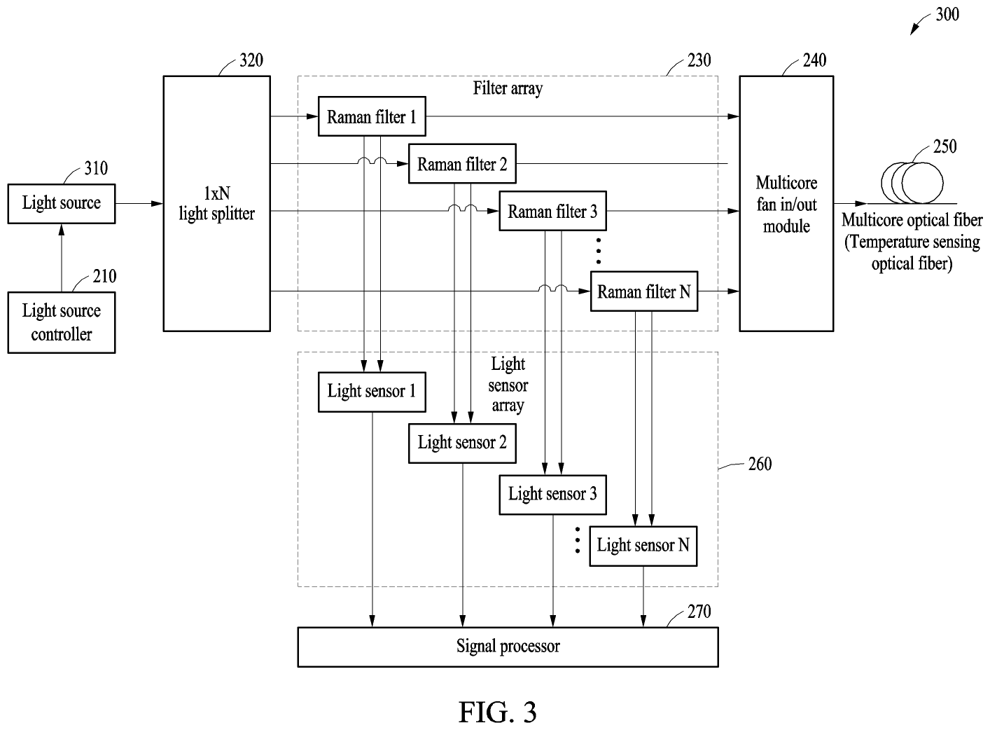

FIG. 3 is a diagram illustrating an example of another configuration of a distributed temperature sensing system using a multicore optical fiber, according to an example embodiment.

Referring to FIG. 3, a distributed temperature sensing system 300 using the multicore optical fiber 250 may be configured by replacing the N light sources 220 in the configuration of the distributed temperature sensing system 200 illustrated in FIG. 2 with a single light source 310 and adding a light splitter 320 to the configuration of the distributed temperature sensing system 200.

The light controller 210 may transmit a control command to the single light source 310 and generate a single sensing-light pulse.

The light splitter 194 may split the single sensing-light pulse generated by the light source 310 into N sensing-light pulses.

The N sensing-light pulses split by the light splitter 194 may respectively be input to the N filters in the filter array 230 and may be injected into each core in the multicore optical fiber 250 by the multicore fan in/out module 240.

Each injected sensing-light pulse may generate scattered light through Raman scattering while moving to and from each core in the multicore optical fiber 250 and may be reflected to the rear of the multicore optical fiber 250.

The scattered light generated at each core, as a reflected-light pulse, together with the sensing-light pulse injected into the multicore optical fiber 250, may be reflected to the rear of the multicore optical fiber 250 and may be input to the filter array 230 by the multicore fan in/out module 240.

The N filters of the filter array 230 may filter the sensing-light pulse from the input reflected-light pulse, separate areflected-light pulse obtained by filtering the sensing-light pulse (that is, scattered light generated by each core) into the first scattered light including stoke components and the second scattered light including anti-stoke components and input the separated first and second pieces of scattered light to the light sensor array 260.

Each light sensor in the light sensor array 260 may convert the first scattered light and the second scattered light to an electrical signal and input the electrical signal to the signal processor 270.

The signal processor 270 may collect and process N pieces of first scattered light and N pieces of second scattered light that are input by the light sensor array 260 to the signal processor 270 and may calculate temperature distribution corresponding to the length of the multicore optical fiber 250.

Accordingly, instead of using all the N light sources, a control command may be selectively transmitted to any one light source 191 that has the highest light power, a single sensing-light pulse may be generated and split by the light splitter 320, N sensing-light pulses may be obtained, and a high-output sensing-light pulse may be injected into the multicore optical fiber 250 at a level where stimulated Raman scattering does not occur in the filter array 230.

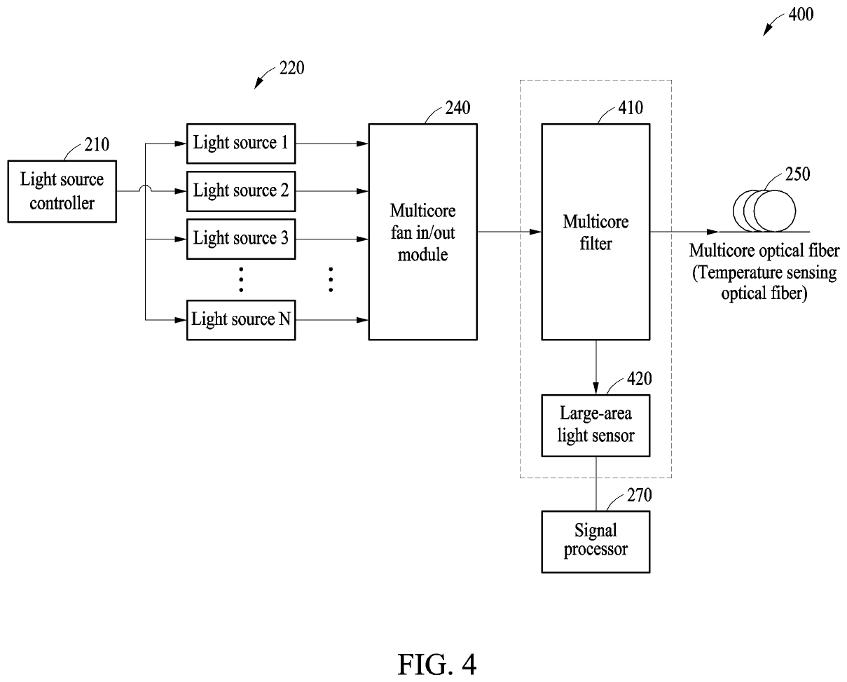

FIG. 4 is a diagram illustrating an example of another configuration of a distributed temperature sensing system using a multicore optical fiber, according to an example embodiment.

Referring to FIG. 4, a distributed temperature sensing system 400 using the multicore optical fiber 250 may be configured by replacing the filter array 193 in the configuration of the distributed temperature sensing system 200 illustrated in FIG. 2 with a multicore filter 410 and adding a large-area light sensor 420 to the configuration of the distributed temperature sensing system 200.

In this case, the multicore filter 410 may include a plurality of cores, and each of the cores may include a combination of a ‘selection filter’ selecting a certain wavelength and a ‘Raman filter’.

The light source controller 210 may modulate current that is input to the N light sources 220 and generate each of sensing-light pulses having light that is output as a pulse.

The multicore fan in/out module 240 may input each of the sensing-light pulses respectively generated by the N light sources 220 to each core included in the multicore filter 410.

Each sensing-light pulse input to each core of the multicore filter 410 may be injected to each core in the multicore optical fiber 250.

Each injected sensing-light pulse may generate scattered light through Raman scattering while moving to and from each core in the multicore optical fiber 250.

The reflected-light pulse including the scattered light and the sensing-light pulse may be reflected from each core of the multicore optical fiber 250 and may be input to each core of the rear of the multicore filter 410.

Each core of the multicore filter 410 may filter the sensing-light pulse from the input reflected-light pulse and separate the scattered light into the first scattered light including stoke components and the second scattered light including anti-stoke components.

The large-area light sensor 420 may sense the first scattered light including stoke components and the second scattered light including anti-stoke components from each core, convert each of the first scattered light and the second scattered light to an electrical signal, and input the electrical signal to the signal processor 270.

In this case, the large-area light sensor 420 may be a light sensor of which an aperture is large enough to accommodate all the light emitted from the multicore filter 410 or a light sensor pigtailed to the multicore optical fiber 250.

The signal processor 270 may collect and process the first scattered light and the second scattered light input from the large-area light sensor 420 and may calculate temperature distribution corresponding to the length of the multicore optical fiber 250.

Accordingly, the configuration of the distributed temperature sensing system 400 may be simplified by using the multicore filter 410 and the large-area light sensor 420, and specifically, by using the large-area light sensor 420 pigtailed to the multicore optical fiber 250, the configuration of the distributed temperature sensing system 400 may be further simplified and costs may be reduced.

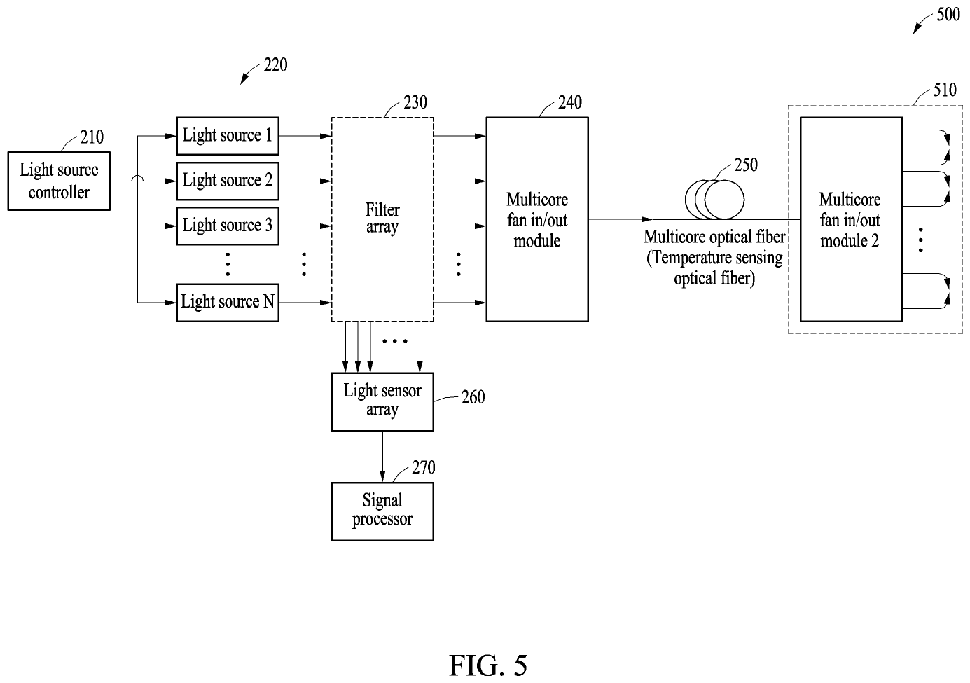

FIG. 5 is a diagram illustrating an example of another configuration of a distributed temperature sensing system using a multicore optical fiber, according to an example embodiment.

Referring to FIG. 5, a distributed temperature sensing system 500 using the multicore optical fiber 250 may be configured by adding a multicore fan in/out module 510 to the other end of the multicore optical fiber 250 in the configuration of the distributed temperature sensing system 200 illustrated in FIG. 2.

The multicore fan in/out module 510 may include a light circuit connecting to every two cores in the multicore optical fiber 250.

The wavelength of the first scattered light including stoke components is different from the wavelength of the second scattered light including anti-stoke components. Therefore, there may be a loss difference between the first scattered light and the second scattered light in the multicore optical fiber 250.

The light circuit may have a double-end structure having two cores. The double-end structure may minimize the loss difference between the first scattered light and the second scattered light. A temperature error derived from the loss difference may be automatically compensated for.

Accordingly, the multicore optical fiber 250 included by the light circuit having a double-end structure may automatically compensate for the temperature error due to the loss difference between the first scattered light and the second scattered light of which the wavelengths are different from each other. Accurate temperature distribution information may be generated by using the first and second scattered light between which the temperature error is compensated for.

In addition, there may be one or more pairs of light circuits depending on the number (N) of cores in the multicore optical fiber 250. For example, there may be

$$\frac{N}{2}$$

light circuits.

When applying the multicore optical fiber 250 including multiple light circuits to a distributed temperature sensing system, an SNR may further increase in proportion to the number of light circuits.

According to example embodiments, an SNR may further increase by applying a cyclic simplex code technique to the distributed temperature sensing system 500 including multiple light circuits having a double-end structure as illustrated in FIG. 5.

In other words, the signal processor 270 may apply pulsed light of which a code length is L to each core having a double-end structure and may apply the same cyclic simplex code to scattered light (that is, sensing data of each core) from each of N cores in the multicore optical fiber 250. When collecting and processing applied results, an SNR may further increase by \sqrt{N} times.

To apply a cyclic simplex code technique, 1) a sensing-light pulse may need to be injected in a certain pattern in which a code length is L for a total time corresponding to the length of the multicore optical fiber 250 and 2) scattered light may need to be collected in every code in the light extractor 140 by the same number of times.

Accordingly, when a cyclic pattern in which a sensing-light pulse is injected is known and an interval of extracting scattered light from a reflected-light pulse is maintained constant, the signal processor 270 may apply the same cyclic simplex code to each piece of scattered light extracted from the reflected-light pulse, and when collecting and processing each piece of scattered light generated in each core, an SNR may increase.

According to example embodiments, each of the N light sources 220 for generating a sensing-light pulse may include an erbium-doped fiber amplifier (EDFA) (not shown) for amplifying an output pulse value of the sensing-light pulse.

The EDFA generally has a slow response time. Therefore, when an input interval of sensing-light pulses to the EDFA is not constant, the amplification rate of the EDFA may vary.

The fluctuation of the EDFA amplification rate may change light power of each sensing-light pulse injected into the multicore optical fiber 250 and may cause an error in a sensing result using a cyclic simplex code.

To maintain the EDFA amplification rate constant, a second sensing-light pulse that is generated through a complementary technique and of which a wavelength is different from that of the sensing-light pulse may be input to the EDFA instead of the sensing-light pulse.

The sensing-light pulse may be input to the EDFA at predetermined input intervals. During an interval at which the sensing-light pulse is not input, the second sensing-light pulse is input to the EDFA instead of the sensing-light pulse. By maintaining an input interval of a light pulse constant, the EDFA amplification rate may be stabilized and light power of each sensing-light pulse injected into the multicore optical fiber 250 may be uniform.

In addition, after the EDFA amplification rate is stabilized, the distributed temperature sensing system 500 may remove the second sensing-light pulse before being input to a Raman filter, or without removing the second sensing-light pulse, may actually use the second sensing-light pulse for sensing a temperature in other cores into which the sensing-light pulse is not injected among the cores of the multicore optical fiber 250.

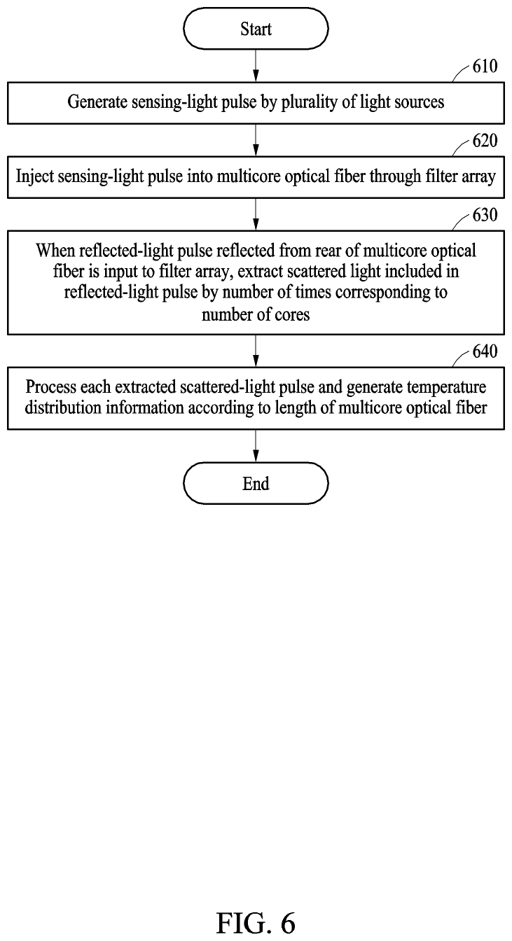

FIG. 6 is a flowchart illustrating an order of a distributed temperature sensing method using a multicore optical fiber, according to an example embodiment.

The distributed temperature sensing method using the multicore optical fiber may be performed by the distributed temperature sensing system 100 described above.

Referring to FIG. 6, in operation 610, the distributed temperature sensing system 100 may generate a sensing-light pulse by a plurality of light sources.

The distributed temperature sensing system 100 may generate the sensing-light pulse. The sensing-light pulse may have as highest output pulse value as possible within an upper limit predetermined such that stimulated Raman scattering may not occur while the sensing-light pulse passes through a filter array before being injected into the multicore optical fiber.

According to example embodiments, the distributed temperature sensing system 100 may have a simple configuration in which the distributed temperature sensing system 100 generates a single sensing-light pulse by any one light source among the plurality of light sources and splits the single sensing-light pulse into a plurality of sensing-light pulses.

In operation 620, the distributed temperature sensing system 100 may inject the plurality of sensing-light pulses into the multicore optical fiber through the filter array.

The filter array may include a ‘selection filter’ selecting a certain wavelength and a ‘Raman filter’. The filter array may pass a first sensing-light pulse of the selected wavelength among the plurality of sensing-light pulses.

The first sensing-light pulse passing through the filter array may be injected into the multicore optical fiber. In operation 630, when a reflected-light pulse that is reflected from the rear of the multicore optical fiber is input to the filter array, the distributed temperature sensing system 100 may extract scattered light included in the reflected-light pulse through the filter array.

The plurality of sensing-light pulses may be scattered by each core in the multicore optical fiber. The reflected-light pulse may include the scattered light that is generated from each core in the multicore optical fiber. The distributed temperature sensing system 100 may repeatedly extract the scattered light included in the reflected-light pulse by the number of times corresponding to the number of cores in the multicore optical fiber.

The filter array may extract the scattered light included in the reflected-light pulse by separating the scattered light into first scattered light including stoke components and second scattered light included anti-stoke components.

In operation 640, the distributed temperature sensing system 100 may process each piece of scattered light extracted by the number of times corresponding to the number of cores and generate temperature distribution information according to the length of the multicore optical fiber.

In other words, the distributed temperature sensing system 100 may collect and process each piece of scattered light extracted by the number of times corresponding to the number (N) of cores and obtain, within a short time, temperature distribution information having a similar accuracy to that of temperature distribution information obtained by using multiple typical single-mode optical fibers. An SNR when processing scattered light may increase in proportion to the number of cores, and a sensing distance upon distributed temperature sensing may increase.

According to example embodiments, the distributed temperature sensing system 100 may include, in the multicore optical fiber, one or more light circuits having a double-end structure by connecting the one or more light circuits to every two cores of the multicore optical fiber.

For example, the double-end structure of a light circuit may minimize a loss difference between the first scattered light and the second scattered light and automatically compensate for a temperature error derived from the loss difference. More accurate temperature distribution information may be generated by using the first scattered light and the second scattered light of which the temperature error is compensated for.

In addition, according to example embodiments, the distributed temperature sensing system 100 may apply the same cyclic simplex code to each piece of scattered light extracted for N cores by using the multicore optical fiber including the light circuit. When summing and processing an applied result, an SNR may further increase by \sqrt{N} times.

In this case, the distributed temperature sensing system 100 may apply the cyclic simplex code to each piece of scattered light when 1) a sensing-light pulse is injected in a certain pattern in which a code length is L for a total time corresponding to the length of the multicore optical fiber and 2) the scattered light may be collected in every code in the light extractor 140 by the same number of times.

In addition, according to example embodiments, the distributed temperature sensing system 100 may input the sensing-light pulse to an EDFA at predetermined input intervals, and during an interval at which the sensing-light pulse is not input, may input a second sensing-light pulse of which a wavelength is different from that of the sensing-light pulse to the EDFA instead of the sensing-light pulse. By maintaining an input interval of a light pulse constant, an EDFA amplification rate may be stabilized, and light power of each sensing-light pulse injected into the multicore optical fiber may be uniform.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of example embodiments have been described above. Nevertheless, it should be understood that various modifications may be made to these example embodiments. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

<Acknowledgement>

The invention of the present patent application is attributed to the following research project.

[Project Identification No.] 1315001785

[Project No.] 20018265

[Ministry Name] Ministry of the Interior and Safety

[Project Management Organization] Korea Evaluation Institute of Industrial Technology

[Project Name] Development of technology to respond to complex social disasters

[Research Task Name] Development of lifecycle, smart safety management technology for solar power facilities in mountain (hill) areas

[Contribution Rate] 1/1

[Research Organization] BK21 Project Team of Inha University

[Research Period] Apr. 1, 2022—Dec. 31, 2024

What is claimed is:

1. A distributed temperature sensing system using a multicore optical fiber, the system comprising:
a light generator configured to generate a plurality of sensing-light pulses by controlling a plurality of light sources;
a light injector configured to input the plurality of sensing-light pulses to a filter array and inject a plurality of first sensing-light pulses corresponding to a selected wavelength that is output from the filter array into the multicore optical fiber;
a light extractor configured to extract scattered light included in a reflected-light pulse when the reflected-light pulse that is reflected from an end of the multicore optical fiber is input to the filter array, based on the injection of the plurality of first sensing-light pulses;
a light sensor configured to convert, to an electrical signal, the scattered light that is extracted by the filter array and transmitted to the light sensor by the light extractor; and
a signal processor configured to process the scattered light converted to the electrical signal to generate temperature distribution information according to a length of the multicore optical fiber, wherein
the reflected-light pulse comprises:
when the first sensing-light pulses are scattered by each core in the multicore optical fiber, the scattered light generated by each core, and
the light extractor is configured to
control the filter array and repeatedly extract the scattered light included in the reflected-light pulse by the number of times corresponding to the number of cores in the multicore optical fiber.

2. The system of claim 1, wherein
the filter array is configured to extract the scattered light included in the reflected-light pulse by separating the scattered light into first scattered light including stoke components and second scattered light including anti-stoke components,
the light sensor is configured to respectively convert, to electrical signals, the first scattered light and the second scattered light that are separated and extracted by the filter array, and
the signal processor is configured to generate the temperature distribution information by processing the first scattered light and the second scattered light that are respectively converted to the electrical signals.

3. The system of claim 2, further comprising
a light circuit connecting to every two cores in the multicore optical fiber is at the other end of the multicore optical fiber, wherein
the light circuit has a double-end structure to minimize a loss error according to a wavelength between the first scattered light and the second scattered light.

4. The system of claim 1, wherein
the filter array is configured to remove a second sensing-light pulse of a wavelength that is not selected from among the plurality of sensing-light pulses and pass the plurality of first sensing-light pulses corresponding to the selected wavelength, and
the light injector is configured to inject, into the multicore optical fiber, the plurality of first sensing-light pulses that passes through the filter array.

5. The system of claim 4, wherein
the light injector is configured to inject, into other cores into which the plurality of first sensing-light pulses is not injected, the second sensing-light pulse that is not removed by the filter array and passes through the filter array.

6. The system of claim 1, wherein
the signal processor is configured to apply a cyclic simplex code technique to the scattered light to increase a signal-to-noise ratio (SNR) of the scattered light extracted by the number of times corresponding to the number of cores in the multicore optical fiber.

7. The system of claim 1, wherein
the filter array comprises a combination of a selection filter and a Raman filter, in which the selection filter is configured to select a wavelength of the plurality of first sensing-light pulses to be passed from among the plurality of sensing-light pulses that is input to the filter array.

8. The system of claim 1, wherein
the light generator is configured to
selectively transmit a control command to one light source among the plurality of light sources and generate a single sensing-light pulse by the light source, and
split the single sensing-light pulse into a plurality of sensing-light pulses by using a light splitter.

9. The system of claim 1, wherein,
when there is a multicore filter instead of the filter array, the light injector is configured to input each of the plurality of sensing-light pulses to each core in the multicore filter, and
inject, into each core in the multicore optical fiber, each of the plurality of first sensing-light pulses corresponding to the selected wavelength that is output from each core in the multicore filter.

10. A distributed temperature sensing method using a multicore optical fiber, the method comprising:
generating a plurality of sensing-light pulses by controlling a plurality of light sources;
inputting the plurality of sensing-light pulses to a filter array and injecting, into the multicore optical fiber, a plurality of first sensing-light pulses corresponding to a selected wavelength that is output from the filter array;
extracting scattered light included in a reflected-light pulse when the reflected-light pulse that is reflected from an end of the multicore optical fiber is input to the filter array, based on the injection of the plurality of first sensing-light pulses;
converting the scattered light extracted by the filter array to an electrical signal; and
processing the scattered light converted to the electrical signal to generate temperature distribution information according to a length of the multicore optical fiber, wherein
the reflected-light pulse comprises, when the first sensing-light pulses are scattered by each core in the multicore optical fiber, the scattered light generated by each core, and
the extracting the scattered light in the reflected-light pulse comprises controlling the filter array and repeatedly extracting the scattered light included in the reflected-light pulse by the number of times corresponding to the number of cores in the multicore optical fiber.
